(19) United States
(12) Patent Application Publication
(10) Pub. No.: US 2010/0192529 A1
(43) Pub. Date: Aug. 5, 2010

(54) FILTER ELEMENT FOR A COALESCING FILTER

(75) Inventor: Hans-Michael Schuster, Haan (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Donaldson Filtraton Deutschland GmbH, Haan (DE)

(21) Appl. No.: 12/596,055

(22) PCT Filed: Apr. 15, 2008
(86) PCT No.: PCT/EP2008/002972

§ 371 Date: Apr. 19, 2010

(30) Foreign Application Priority Data
Apr. 16, 2007 (DE) 20 2007 005 552.8

(51) Int. Cl. B01D 46/52

(52) U.S. Cl. 55/486

(57) ABSTRACT

The invention relates to a filter element for a coalescing filter, comprising an outer support sleeve, a coalescing layer and a filter medium, wherein the coalescing layer is substantially structurally separate from the filter medium.

The invention relates to a filter to remove oil or condensate from compressed air or gases, as used, for example, in the instrument air supply or for the compressed air plant technology to remove aerosol from gases. These filters are known as coalescing filters.

The majority of coalescing filters known in the state of the art involve filter devices with an outer coalescing jacket. This coalescing jacket has the task to further cleanse the liquid or oil droplets accumulated by the actual filter material and to supply them to a common drain line. The coalescing jacket typically encloses a support sleeve of mesh-like pervious and substantially solid material.

An outer coalescing jacket has, however, drawbacks during production of the coalescing filter. For example, the tight attachment of the jacket onto the firm support sleeve can be a problem when the coalescing material is very firm; when more elastic material is involved, the elongation can adversely affect the efficiency during operation.

German laid-open document DE 195 20 504 A1 discloses a coalescing filter which is characterized i.a. by an outer support sleeve, i.e. an outer support sleeve surrounds a coalescing material placed inside this support sleeve. The coalescing material is constructed as a so-called intermediate layer which in pleated form bears upon a filter medium which is also pleated. Thus, the filter body according to the DE 195 20 504 A1 is comprised of a filter medium and an intermediate layer fulfilling the coalescing function, which are both pleated and processed and used as a unitary layer.

It has now been surprisingly found that the filter efficiency of a coalescing filter with outer support sleeve can be enhanced when the coalescing layer is not part of the filter body, but rather as a separate element placed within the filter element. The filter body is hereby the one component of the filter element which substantially assumes the filtering function of the filter device. Subject matter of the invention is thus the provision of a filter element with an outer support sleeve in surrounding relationship to a filter medium with a coalescing layer which is substantially structurally separated therefrom.

The term “structurally substantially separate” relates within the scope of the present invention to a coalescing layer which does not form an (integral) part of the filter body including the filter medium, and thus, for example, cannot be processed or treated—pleated for example—in a common operating step with the filter medium. Of course, the coalescing layer may form a functional unit with the filter medium.

According to a preferred embodiment, the coalescing layer does not substantially bear upon the filter medium. Advantageously, the coalescing layer bears with its inner surface upon the filter medium only by less than 50%, preferably by less than 30%, particularly preferred by less than 10%. In these embodiments, the filter medium may, for example, be pleated while the coalescing layer is not pleated. Involved is hereby the wound

According to another embodiment, the coalescing layer which is structurally substantially separate from the filter medium may directly bear upon the filter medium in its entirety or also by way of large parts.

As already described, the coalescing filter exhibits a still further enhanced filtering efficiency in comparison to conventional coalescing filters. This has been proven by respective measurements according to DIN ISO standards 12500 Part 1 (“Filters for compressed air. Test method. Part 1: Oil aerosols”) and according to DIN ISO 8573 Part 2 (“Compressed air. Part 2: Test methods for oil aerosol content”).

Any typical materials may be used as coalescing material for the filter according to the invention. Typical materials include, i.a., foamed material or also nonwoven polyester fibers. Examples of further coalescing materials are known from the DE 195 20 504 A1.

Examples of suitable filter media are also known to the artisan. An example may include glass fiber paper. Glass fiber papers with suitable properties are also referred to in the German laid-open document DE 195 20 504 A1.

An exemplary embodiment of the invention will be described in greater detail hereinafter. It is shown in:

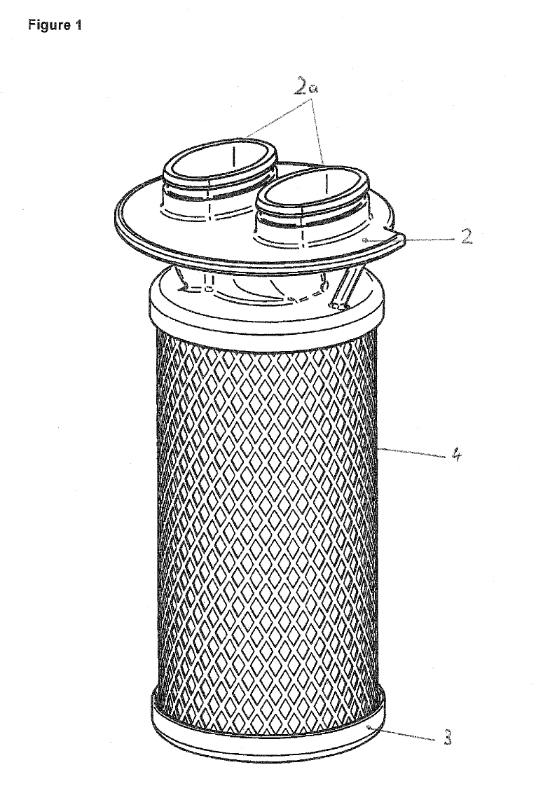

FIG. 1 an overall view of a filter element according to the invention;

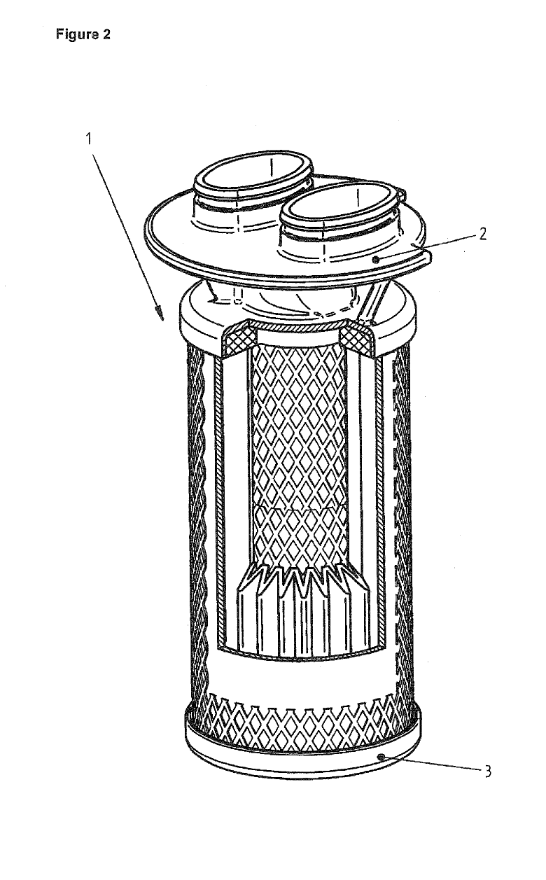

FIG. 2 a partial elevation of a filter element according to the invention; and

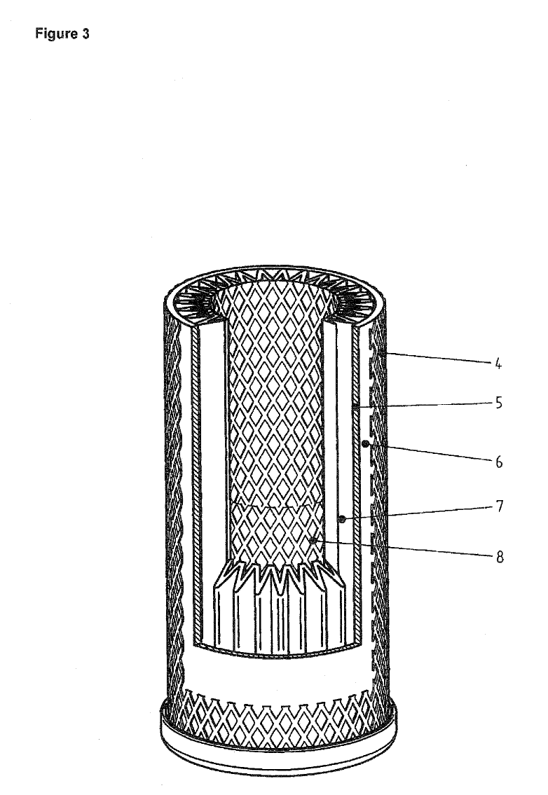

FIG. 3 a cross section through a filter element according to the invention.

The filter element 1 according to the invention includes an upper and a lower end cap (2; 3). A mesh-like outer support sleeve 4 surrounds the coalescing jacket 5 which bears with its outer surface 6 upon the outer support sleeve 4. Portions of the inner surface of the coalescing jacket 5 rest against the pleated filter medium 7. The pleated filter medium is supported on the inside by an inner support sleeve 8. Like the outer support sleeve, this support sleeve, too, has a preferably mesh-like configuration and is thus fully pervious.

1.-5. (canceled)

6. A filter element for a coalescing filter, comprising:
an outer support sleeve;
a pleated filter medium; and
an unpleated coalescing layer placed between the outer support sleeve and the filter medium and having an inner surface, with less than 50% of the inner surface directly bearing upon the filter medium.

7. The filter element of claim 6, wherein less than 30% of the inner surface of the coalescing layer bears upon the filter medium.

8. The filter element of claim 6, wherein less than 10% of the inner surface of the coalescing layer bears upon the filter medium.

9. The filter element of claim 6, further comprising an inner support sleeve placed inwardly of the filter medium for support of the filter medium.
